(19) United States
(12) Patent Application Publication
(10) Pub. No.: US 2007/0050470 A1
(43) Pub. Date: Mar. 1, 2007

(54) Display method and system of computer information

(76) Inventors: Norio Suzuki, Yokohama (JP); Tsutomu Kontani, Hujisawa (JP); Yoshiko Sakanishi, Nakai (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/298,746

(22) Filed: Dec. 12, 2005

(30) Foreign Application Priority Data
Aug. 31, 2005 (JP) 2005-250520

(51) Int. Cl. G06F 15/16

(52) U.S. Cl. 709/217

(57) ABSTRACT

A method is provided for sending state and setting information on a local terminal to a remote terminal, for displaying the information, which is received, in an appropriate area in screen information on the remote terminal side, and for sending the processed screen information to the local terminal for display on the display of the local terminal. Also provided is a method for displaying the state and setting information on the local terminal in a transparent window through which underlying images can be seen.

### INCORPORATION BY REFERENCE

This application relates to and claims priority from Japanese Patent Application No. 2005-250520 filed on Aug. 31, 2005 the entire disclosure of which is incorporated herein by reference.

### BACKGROUND OF THE INVENTION

The present invention relates to a system and a method for merging machine information on one computer (for example, local computer) and screen information on another computer (for example, remote computer) and displaying the merged information on a display of one of the computers connected to a network composed of wired, wireless, mobile phone, or PHS communication networks.

A technology is widely known that displays the screen information of a network-connected remote terminal on the display of a local terminal for operating the remote terminal from the local terminal, for monitoring the remote terminal, or for sharing the screen information with the remote location (for example, JP Patent NO. 2753277).

### SUMMARY OF THE INVENTION

The display of a personal computer usually includes an area for constantly displaying the status of, and the setting information on, the terminal and the operating system (hereinafter, this display area is called a task tray) and an area for displaying icons for starting programs or applications and icons for controlling the terminal (for example, shutting down or rebooting the terminal). Those areas and icons allow the user to check the current time of the terminal and the operating system, to confirm the status such as the audio output status, network connection status, and power status, to start programs, and to control terminals and the operating system.

However, in a system where screen information on a remote terminal is displayed on the display of a local terminal, the information on the remote terminal is displayed but not the information on the local terminal. Even if displayed, the information on the local terminal cannot be distinguished from the information on the remote terminal and the screen is difficult to view. In addition, when the information on the local terminal is overlapped on the screen information on the remote terminal, the operability and the visibility of the overlapped screens are decreased. If the information on the local terminal is put in the non-display mode, the user has no way to know the information on the local terminal and fails to notice a battery exhaustion or an insufficient disk memory condition, sometimes with the result that important data is lost. To start a program on the local terminal or to shutdown and reboot the local terminal, the user must press the control keys such as Esc and (Ctrl+Alt+Del) to cause an interrupt. Such operations degrade the operability of the local terminal control operations

It is an object of the present invention to provide a display method and a display system for displaying both screen information on a remote terminal and information on a local terminal without degrading the operability and visibility of the screen of the local terminal display.

To solve the problems described above, the present invention provides means for sending the state and setting information on a local terminal, a program start icon, and a terminal control icon (hereinafter called terminal information) to a remote terminal, for displaying the terminal information, which is received, in an appropriate area in screen information on the remote terminal side, and for sending the processed screen information to the local terminal for display on the display of the local terminal.

The terminal information on the local terminal is sent to the remote terminal to display it on the screen of the remote terminal. This allows the local terminal to display the terminal information on the local terminal in the screen display area of the remote terminal. More specifically, an operating system instruction is captured or the API (Application Program Interface) is used on the operating system of the local terminal to acquire the state and setting information (terminal information) on the local terminal. The terminal information acquired by the local terminal is sent to the remote terminal at a regular interval, when operation control information is sent to the remote terminal, or when an information change event is received. The remote terminal displays the received terminal information in the task tray of the operating system of the remote terminal or on the remote terminal screen as a transparent window. As an icon for controlling the local terminal (program start and shutdown or reboot), either an icon created by acquiring information from the local terminal and sending to the remote terminal or an icon predetermined by the remote terminal may be displayed.

The displayed terminal information is transferred to the local terminal as a part of the screen information on the remote terminal and is displayed as a part of the screen display area of the remote terminal.

A keyboard/mouse input to the local terminal is captured as screen operation information to the remote terminal and is sent to the remote terminal.

The remote terminal displays the detailed information on the terminal information, acquired from the local terminal, when a keyboard/mouse input is an input to a display icon on the terminal information on the local terminal, or returns a program start or terminal control instruction to the local terminal when the keyboard/mouse input is an input to a control icon for the program or the terminal. The local terminal receives the program start or terminal control instruction from the remote terminal and starts the program specified by the local terminal or performs the specified shutdown or remote processing.

The present invention also provides means for displaying the terminal information on the local terminal in a transparent window, through which underlying images can be seen, without sending the terminal information on the local terminal to the remote terminal.

In this case, the local terminal overlaps screen information, created by processing its own terminal information into a transparent window, on the screen information received from the remote terminal.

When a keyboard/mouse input on the local terminal is an input to an icon in the transparent window, the local terminal captures the input not as screen operation information for the remote terminal but as an input to the local terminal. When the keyboard/mouse input is an input to one of the displayed icons, the detailed information on the terminal information is displayed. When the input is an input to one of the control icons indicating a program or a terminal, the specified program is started or the system is shut down or rebooted.

The method according to the present invention allows the user to display the screen information about a remote terminal, which is connected via a network, on the display of the local terminal, thus allowing the user to operate or monitor the remote terminal from the local terminal. In a system where the screen information is shared with a remote terminal, the icons for indicating the state and setting information on the local terminal and for starting a program or controlling the terminal can be displayed in the screen display area of the remote terminal. This allows the user to confirm the state and setting information on the local terminal or to start a program on the local terminal or perform terminal control processing.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the external view of a remote operation system.

FIG. 2 is a diagram showing an example of the control sequence between a controller terminal and an agent terminal.

FIG. 3 is a diagram showing an example of the module configuration of the controller terminal and the agent terminal and the flow of data.

FIG. 4 is a diagram showing an example of the module configuration of the controller terminal and the agent terminal and the flow of screen data.

FIG. 5 is a diagram showing an example of the data format of a power information temporary saving buffer.

FIG. 6 is a diagram showing an example of the data format of a speaker information temporary saving buffer.

FIG. 7 is a diagram showing an example of the data format of a communication information temporary saving buffer.

FIG. 8 is a diagram showing an example of the data format of the sending buffer of operation control information and terminal information.

FIG. 9 is a diagram showing an example of the data format of the sending buffer of terminal control information.

FIG. 10 is a diagram showing an example of the data format of a terminal control information definition table.

FIG. 11 is a diagram showing an example of the time adjustment method and the communication speed calculation method between the controller terminal and the agent terminal.

FIG. 12 is an example of a flowchart showing that power information is acquired and stored in the temporary saving buffer.

FIG. 13 is an example of a flowchart showing that speaker information is acquired and stored in the temporary saving buffer.

FIG. 14 is an example of a flowchart showing that communication information is acquired and stored in the temporary saving buffer.

FIG. 15 is an example of a flowchart showing the flow of the analysis of an operation event.

FIG. 16 is an example of a flowchart showing that a keyboard/mouse input event is captured and sent to the sending buffer.

FIG. 17 is an example of a flowchart showing the analysis processing of information sent from the controller terminal.

FIG. 18 is a diagram showing an example of icons, which indicate terminal information, displayed in the task tray of the agent terminal.

FIG. 19 is a diagram showing an example of icons, which indicate terminal information, displayed on the desktop of the controller terminal.

FIG. 20 is a diagram showing an example of a popup window displayed when a battery icon is pointed.

FIG. 21 is a diagram showing an example of a popup window displayed when a speaker icon is pointed.

FIG. 22 is a diagram showing an example of a popup window displayed when a communication icon is pointed.

FIG. 23 is a diagram showing an example of a battery icon table.

FIG. 24 is a diagram showing an example of a speaker icon table.

FIG. 25 is a diagram showing an example of a communication icon table.

### DETAILED DESCRIPTION OF THE EMBODIMENTS

In the description below, a remote terminal is referred to as an agent terminal, and a local terminal as a controller terminal.

Preferred embodiments of the present invention will be described below in detail with reference to the drawings.

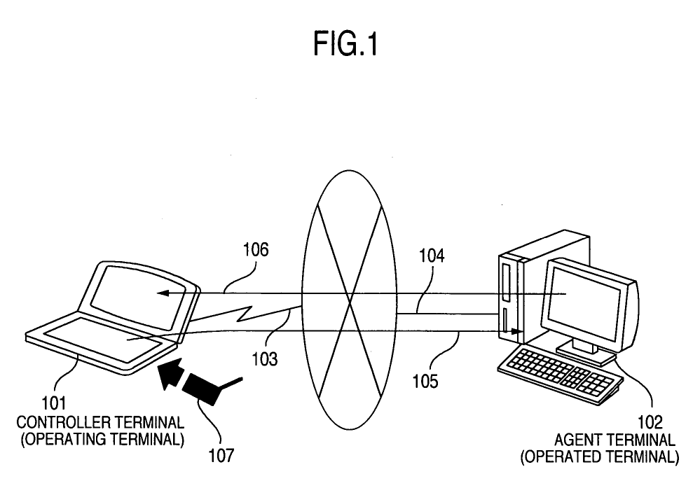

FIG. 1 is a diagram showing the external view of a remote operation system in one embodiment of the present invention.

Although it is assumed that a communication line 103 is a wireless line and a network 104 is a wired network in the embodiment, the actual system is not limited to the communication line and the network used in the embodiment.

A controller terminal 101, in which a wireless LAN card or a portable communication card 107 is inserted, communicates with an agent terminal 102 via the communication line 103 and the network 104. The display of the controller terminal 101 includes the information on the same screen as that of the display of the agent terminal 102, and a keyboard/mouse input is sent from the controller terminal 101 to the agent terminal 102 as an input to the agent terminal 102 for execution thereon. In response to the keyboard/mouse input from the controller terminal 101, the agent terminal 102 can execute an operation for the operating system and for an application running on the agent terminal 102 (105). The agent terminal 102 sends the screen information of the agent terminal 102 to the controller terminal 101 (106). Many applications display the execution results on the display. The screen information on this display is sent from the agent terminal 102 to the controller terminal 101 for display on the display of the controller terminal 101 to allow the controller terminal 101 to confirm the execution results.

In the configuration described above, because the controller terminal 101 can execute the function of the display, the keyboard, and the mouse of the agent terminal 102, the agent terminal 102 may not need to have the display, the keyboard, and the mouse.

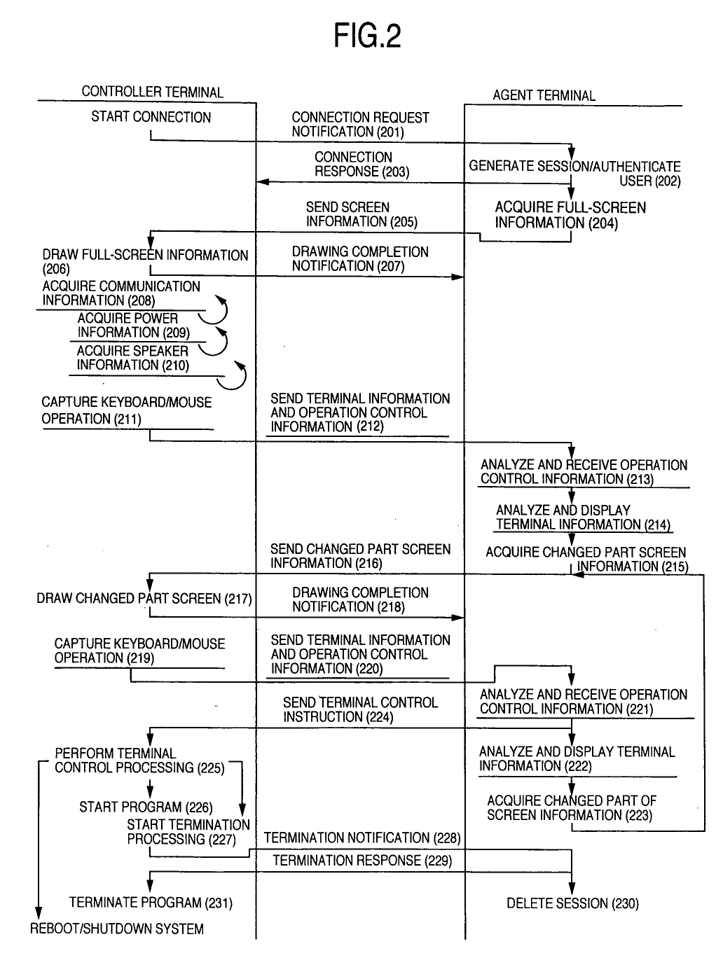

FIG. 2 is a diagram showing an example of processing and the data flow executed between a controller terminal and an agent terminal in this embodiment.

To start communication between the controller terminal and the agent terminal, the controller terminal sends a connection request notification to the agent terminal (201). In response to the connection request notification, the agent terminal generates a session, authenticates the user (202), and sends a connection permission response to the controller terminal (203). The agent terminal acquires full-screen information (204) and sends it to the controller terminal (205). The controller terminal draws the received full-screen information on the display (206) and sends a drawing completion notification to the agent terminal (207).

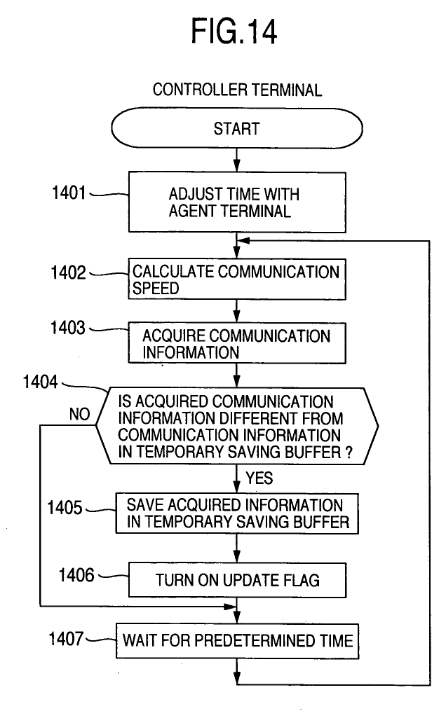

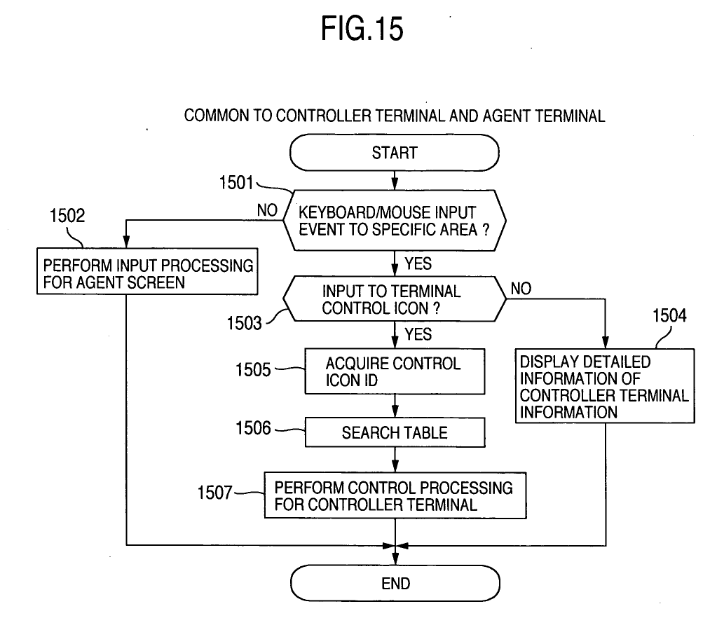

The controller terminal measures the communication speed between the agent terminal and the controller terminal at a regular interval asynchronously with the acquisition of a drawing instruction for a change in the screen and stores the acquired communication information in the buffer (208). The contents of the communication information will be described later with reference to FIG. 7, and the communication information acquisition processing will be described later with reference to FIG. 14.

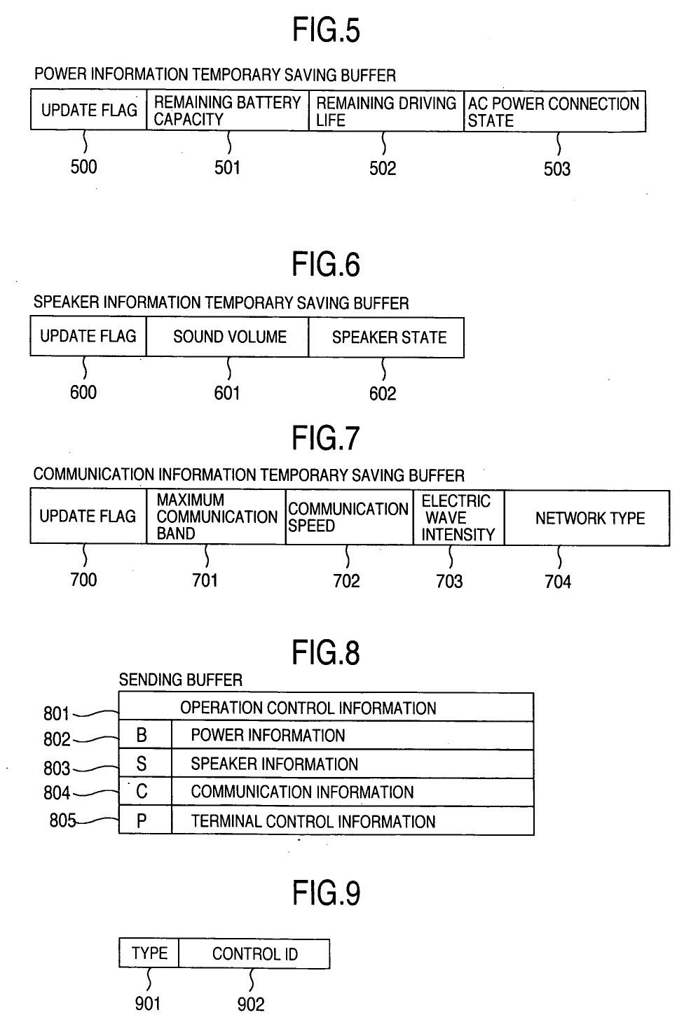

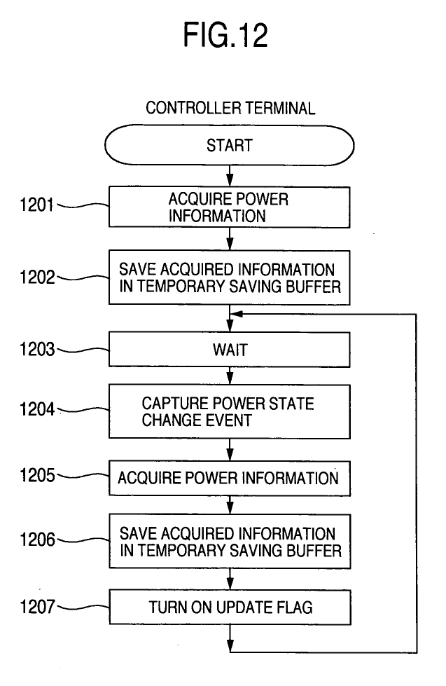

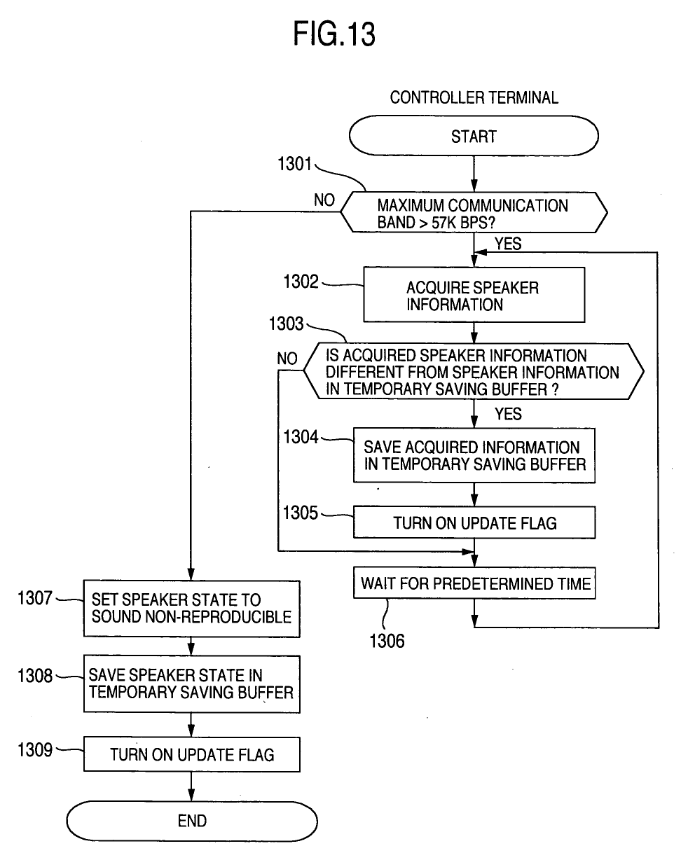

Similarly, the controller terminal captures a power change event from the operating system and stores the acquired power information in the buffer (209). The contents of the power information will be described later with reference to FIG. 5, and the power information acquisition processing will be described later with reference to FIG. 12. The controller terminal also acquires speaker setting information from the operating system and the driver and stores the acquired setting information in the buffer (210). The acquired speaker information will be described later with reference to FIG. 6, and the speaker information acquisition processing will be described later with reference to FIG. 13.

When a keyboard operation or a mouse operation is generated in the controller terminal, the controller terminal captures the keyboard/mouse input event and stores it as the operation control information (211).

The controller terminal sends the controller terminal information composed of the power information, the communication information, and the speaker information stored in the buffers (hereinafter, the information is called collectively as terminal information) to the agent terminal. That is, upon capturing a keyboard/mouse input event, the controller terminal sends the operation control information as well as the terminal information to the agent terminal (212). The flow of processing from the time a keyboard/mouse input event is captured to the time the terminal information is sent will be described later with reference to FIG. 16.

Although sent upon capturing a keyboard/mouse input event in this example, the terminal information may also be sent upon capturing a change event of the terminal information or at a regular interval as long as the terminal information is notified to the agent terminal.

The agent terminal analyzes the received operation control information and sends the information to the operating system as a keyboard/mouse event. The agent terminal also analyzes the terminal information and draws or redraws the screen information in a predetermined position on the agent terminal screen as a transparent window or a bitmap icon (214). When the screen information is changed, the agent terminal captures a drawing instruction for the screen change and acquires the screen information about the changed part (215). The agent terminal sends the screen information about the acquired changed part to the controller terminal (216). The controller terminal draws the received screen information about the changed part on the display (217) and sends the drawing completion notification to the agent terminal (218).

The agent terminal acquires and sends the screen information about the changed part, and the controller terminal draws it on the display, each time the screen information is changed.

Information on the position or the area in which a transparent window or a bitmap icon is displayed is stored in the memory of the agent terminal or in the storage device such as a hard disk. The transparent window or the bit map icon are drawn in the predetermined position or area.

When the screen information is not changed, the screen information about the changed part is neither acquired nor sent.

The processing of steps 208, 209, 210, 211, and 215 is executed asynchronously when each event occurs.

The controller terminal captures an operation on the keyboard or the mouse (219) and sends operation control information as well as the terminal information to the agent terminal (220). The agent terminal analyzes the received operation control information and, if the information is an input to the screen of the agent terminal, sends the information to the operating system as a keyboard/mouse event (221) in the same manner as described above. The agent terminal analyzes the terminal information and, if it is found that the information is changed, re-draws the screen information as a transparent window or a bit map icon (222), acquires the screen information about the changed part (223), and sends it to the controller terminal (216).

The agent terminal analyzes the received operation control information and, if the operation is an input to the transparent window or the bit map icon related to the controller terminal information, performs the following processing. That is, if the operation is an input to a display icon, the agent terminal displays the icon with the information from the controller terminal associated with the specified icon; if the operation is an input to a terminal control icon, the agent terminal sends a terminal control instruction to the controller terminal (224). In response to the terminal control instruction, the controller terminal performs terminal control processing according to the instruction (225). If the operation is an instruction to start a program, the controller terminal starts the program (226); if the operation is an instruction to shutdown or reboot the system, the controller terminal starts termination processing (227) and sends a reboot/shutdown instruction to the operating system (232).

To terminate the remote operation system, the controller terminal starts termination processing (227) and sends a connection termination notification to the agent terminal (228). In response to the connection termination notification, the agent terminal returns a response (229) and discards the session (230). In response to the response from the agent terminal, the controller terminal terminates the program (231).

FIG. 2 shows how the terminal information on the controller terminal is sent to, and displayed on, the agent terminal. Note that, instead of sending the terminal information on the controller terminal to the agent terminal, it is also possible for the controller terminal to receive screen information from the agent terminal and display the information on the controller terminal itself on the controller terminal as a transparent window.

In this case, instead of sending the terminal information on the controller terminal to the agent terminal, the controller terminal processes the information on the controller terminal itself into a transparent window and overlaps the transparent window on the screen information received from the agent terminal. A keyboard/mouse operation captured by the controller terminal is processed as follows. If the operation is an input to the terminal information in the transparent window and if the operation is an input to a display icon, the controller terminal displays the detailed information of the terminal corresponding to the specified icon and, if the operation is an input to a terminal control icon, performs terminal control processing corresponding to the specified icon. If the operation is an instruction to start a program, the controller terminal starts the program; if the operation is an instruction to shutdown or reboot the system, the controller terminal starts termination processing and sends a reboot/shutdown instruction to the operating system.

If the operation is an input to the screen information on the agent terminal, the controller terminal sends it to the agent terminal as the operation control information.

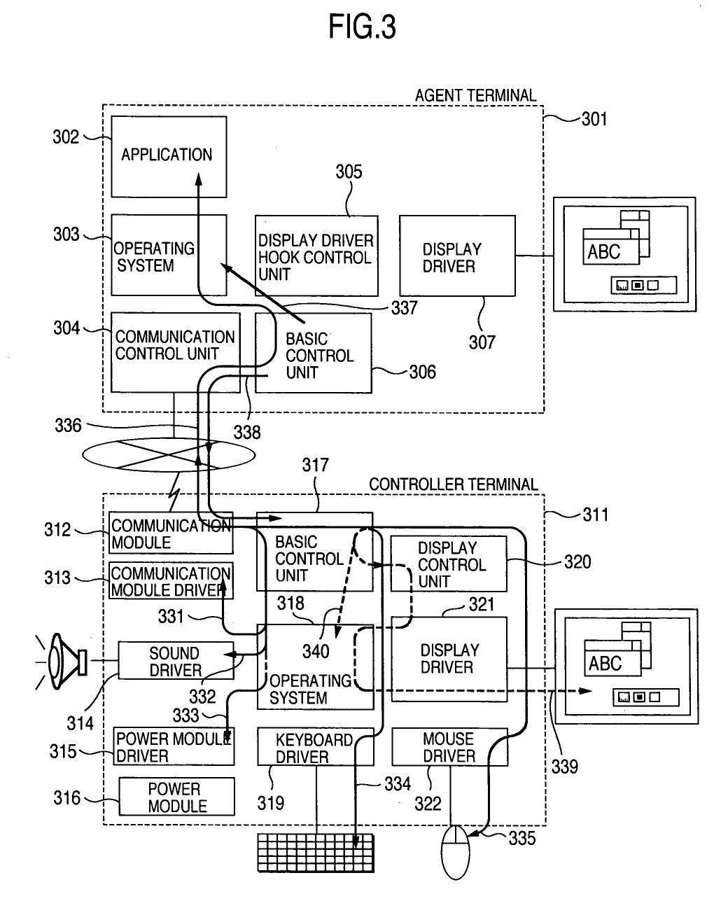

FIG. 3 is a diagram showing the module configuration of the controller terminal and the agent terminal in the embodiment and the flow of data and control. This figure shows the data flow and the control flow when the controller terminal acquires terminal information and operation control information, sends the data to the agent terminal, and displays the terminal information on the agent terminal.

The following software modules run in an agent terminal 301: a communication control unit 304 that controls communication to or from a controller terminal 311, a display driver hook control unit 305 that captures a drawing instruction that is output from an operating system 303 to a display driver 307, and a basic control unit 306 that integrally controls the control units, analyzes and executes the terminal information and the operation control information on the controller terminal, and acquires a drawing instruction from the display driver hook control unit for processing it. At drawing time, the screen information is drawn using the information stored in a nonvolatile external storage device or a nonvolatile internal storage unit not shown.

The basic control unit 306 in the agent terminal analyzes information (operation control information, communication information, speaker information, and power information) 336 received from the controller terminal. If not an input to the display area of the information received from the controller terminal, the analyzed operation control information is sent to the operating system 303 and an application 302 for execution. If the analyzed operation control information is an input to the display area of the information received from the controller terminal and is an input to a display icon, the communication information, the speaker information, and the power information are changed into a drawing instruction that is passed from the basic control unit to the operating system as modified screen information (337). If the received information is an input to a terminal control icon, the basic control unit 306 sends a terminal control instruction to the controller terminal (338).

It is also possible for the basic control unit 306 to include a screen combination processing unit, not shown, which modifies the screen information on the agent terminal based on the information 336 received from the controller terminal. In this case, the modified screen can be created without changing the screen information held by the operating system of the agent terminal.

The following software modules run in the controller terminal 311: a communication module 312 that communicates with the agent terminal 301, a communication module driver 313 that controls the communication module, a sound driver 314 that controls the sound, a power module driver 315 that controls a power module 316, a keyboard driver 319 that controls the keyboard, a mouse driver 322 that controls the mouse, a display control unit 320 that restores a drawing instruction from the agent terminal 301 and executes the drawing instruction for the operating system, a display driver 321 that displays actual drawing data by the drawing instruction from an operating system 318, and a basic control unit 317 that integrally controls the controllers.

The basic control unit 317 of the controller terminal sends an input event (334, 335) of the keyboard/mouse, captured via the keyboard driver 319 and the mouse driver 322, to the agent terminal via the communication module 312. The basic control unit 317 also acquires the communication information (331), the speaker information (332), and the power information (333) from the operating system 318 regularly or upon receiving a change message from the operating system 318 and sends the acquired information, along with the operation control information, to the agent terminal when the operation control information is sent.

The controller terminal may also have a nonvolatile storage device in which information from the agent terminal is stored for use in an offline job. It is also possible to store processing information only in a volatile storage device to ensure security against the theft of the controller terminal.

FIG. 3 shows the method in which the terminal information on the controller terminal is sent to, and displayed on, the agent terminal. Note that, instead of sending the terminal information on the controller terminal to the agent terminal, it is also possible to receive screen information from the agent terminal and display the information about the controller terminal itself on the controller terminal as a transparent window.

In this case, the screen combination processing unit, not shown in the figure but included in the basic control unit of the controller terminal, processes the information on the controller terminal itself into a transparent window and overlaps the transparent window on the screen information received from the agent terminal. The keyboard/mouse operation captured by the controller terminal is processed as follows. If the operation is an input to the terminal information in the transparent window, the basic control unit (317) captures the operation. If the operation is an input to a display icon, the basic control unit 317 displays the detailed information of the terminal corresponding to the specified icon and, if the operation is an input to a terminal control icon, performs terminal control processing corresponding to the specified icon. To perform display processing, the basic control unit 317 passes a drawing instruction to the display control unit (339). If the operation is an instruction to start a program, the basic control unit 317 starts the program; if the operation is an instruction to shut down or reboot the system, the basic control unit 317 starts termination processing and sends a reboot/shutdown instruction to the operating system (340).

If the keyboard/mouse operation is an input to the screen information on the agent terminal, the basic control unit 317 sends the input to the agent terminal as the operation control information (336).

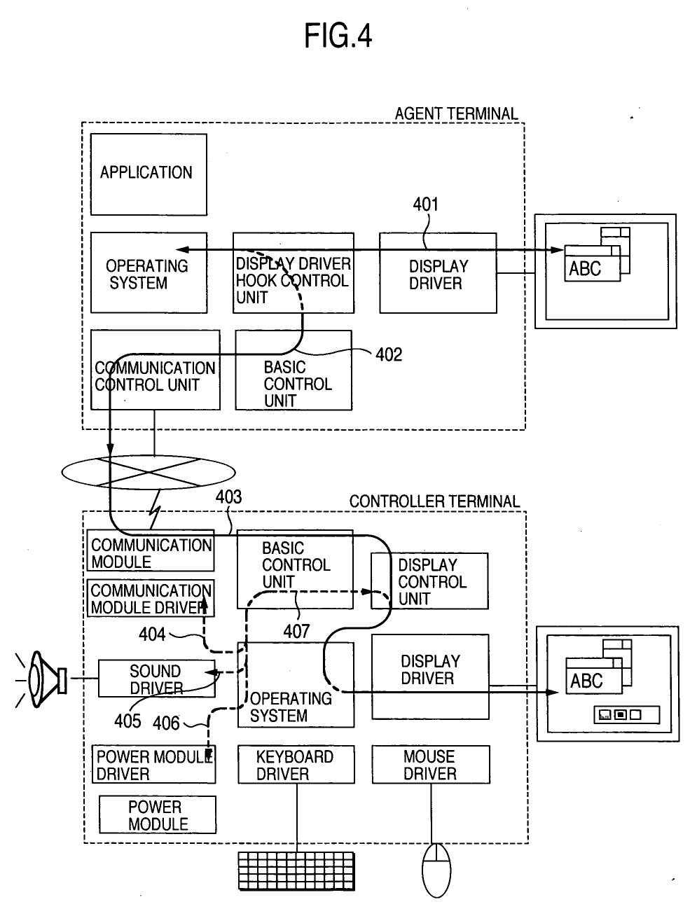

FIG. 4 is a diagram showing the data flow and the control flow when drawing information acquired by the agent terminal is sent to, and displayed on, the controller terminal.

When a drawing instruction 401 is transferred from the operating system 303 in the agent terminal, the display driver hook control unit captures a drawing instruction for the screen data part that is changed. The captured drawing instruction is optimized by the basic control unit 306 and is sent to the controller terminal via the communication control unit 304.

The basic control unit 317 in the controller terminal restores the received drawing instruction to the drawing instruction captured by the display driver hook control unit. The restored drawing instruction is displayed on the display via the operating system 318 and the display driver 321.

When the controller terminal information (operation control information, communication information, speaker information, and power information) is not sent from the controller terminal to the agent terminal but the controller terminal processes its terminal information and displays it on the received agent terminal screen, the basic control unit acquires the communication information (404), speaker information (405), and power information (406) from the operating system 318 and controls the display so that the terminal information is displayed on the received screen (407).

In the example shown in FIG. 4, when screen information (drawing instruction) for displaying the screen is sent to the controller terminal, the controller terminal information such as the communication information, the speaker information, and the power information is already included in the screen information in order to display the same screen on both the agent terminal and the controller terminal. It is also possible to display the controller terminal information only on the controller terminal. To do so, instead of reflecting the controller terminal information on the screen information when the controller terminal information is received from the controller terminal in the processing shown in FIG. 3, the screen combination processing unit, which is included in the basic control unit (306) in the agent terminal but not shown, reflects the controller terminal information on the screen information, created by the agent terminal, before sending it to the controller terminal.

FIG. 5 shows the data in the saving buffer in which power information, acquired from the operating system by the basic control unit in the controller terminal, is temporarily saved. The power information comprises a remaining battery capacity 501 that indicates the percentage of the remaining battery capacity when the information was acquired, a remaining driving life 502 that indicates the length of time during which the controller terminal can be driven by the reaming battery capacity, an AC power connection state 503 that indicates whether the battery is connected to the AC power, and an update flag 500 that indicates whether the data was updated.

FIG. 6 shows the data in the saving buffer in which speaker information, acquired from the operating system by the basic control unit in the controller terminal, is temporarily saved. The speaker information comprises a sound volume 601 that indicates the sound volume in the operating system when the information was acquired, a speaker state 602 that indicates whether the sound volume of the operating system is in the mute state, and an update flag 600 that indicates whether the data was updated. If the maximum communication band of the controller terminal is equal to or lower than a predetermined level, the flag indicating that the speaker cannot reproduce sound is set in the speaker state 602.

FIG. 7 shows the data in the saving buffer in which communication information, acquired from the operating system by the basic control unit in the controller terminal, is temporarily saved. The communication information comprises a maximum communication band 701 that indicates the maximum communication band in the operating system when the information was acquired, a communication speed 702 that indicates the data transfer speed between the agent terminal and the controller terminal, an electric wave intensity 703 that indicates the intensity of the electric wave when the controller terminal is connected wirelessly, a network type 704 that indicates the connection state indicating whether the controller terminal is connected wirelessly or via a wire, and an update flag 700 that indicates whether the data was updated.

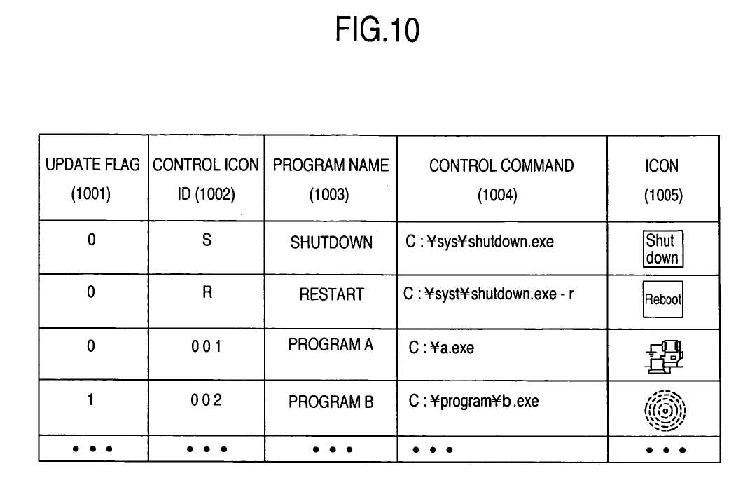

FIG. 8 shows the sending data format of the operation control information and the terminal information sent from the controller terminal to the agent terminal. The sending data comprises operation control information 801, power information 802, speaker information 803, communication information 804, and terminal control information 805. When any of the information 802-805 is updated, the information is sent with only the updated information added to the operation control information 801. The operation control information 801 is generated by capturing and encoding a keyboard/mouse input on the controller terminal. Upon receiving this information, the agent terminal decodes it and uses it for the execution of an application and the operating system. The information 802-805 includes data in the temporary saving buffers shown in FIGS. 5-7 and the terminal control information added to the table in FIG. 10. The first byte of the information contains the flag (‘B’, ‘S’, ‘C’, and ‘P’ in the figure) indicating the contents of the stored information to allow the agent terminal to know the contents of data that follows this flag.

FIG. 9 is a diagram showing the sending data format of a terminal control instruction that is sent from the agent terminal to the controller terminal. This sending data comprises a type 901 and a control ID 902. To distinguish this sending data from a message sent with screen information, the type 901 contains the control icon ID 902 defined in the terminal control information definition table in FIG. 10 that will be described later.

FIG. 10 is a diagram showing the terminal control information definition table. The terminal control information comprises a control icon ID 1002 that uniquely identifies a terminal control icon, a program name 1003, a control command 1004 executed during actual control processing, an icon 1005 used when the information is displayed on the screen, and an update flag 1001 that indicates whether the data was updated.

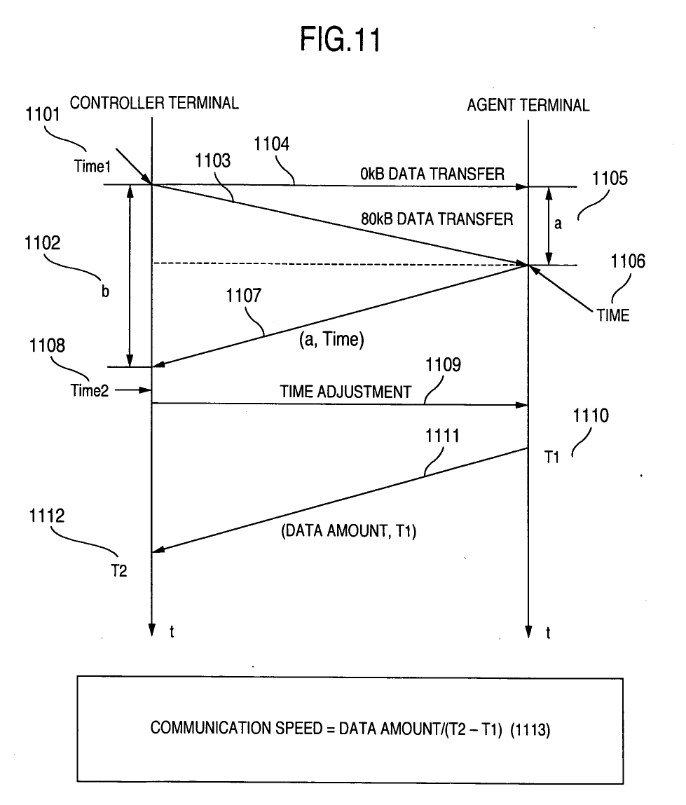

FIG. 11 is a diagram showing a time adjusting method for adjusting the time between the controller terminal and the agent terminal and a communication speed calculation method.

First, the following describes the procedure for adjusting the time between the controller terminal and the agent terminal. The first dummy data, 0 KB in size, and the second dummy data, 80 KB in size, are sent from the controller terminal to the agent terminal at the same time (1103, 1104). At this time, the sending time Time1 (1101) is acquired and, at the same time the data is sent, the timer (b) is started.

When the agent terminal receives the first dummy data, it starts the timer (a). When the reception of the second dummy data is completed, the agent terminal immediately returns the second dummy data to the controller terminal (1107). At this time, the agent terminal adds two types of data to the dummy data: one is the elapsed time a (1105) from the time the first dummy data was received and the other is TIME (1106) which is the sending time.

The controller terminal calculates the difference of time between the controller terminal and the agent terminal from the dummy data sending time Time1 (1101), the elapsed time b (1102), the receiving side elapsed time a (1105), and the sending time TIME (1106) as follows.
Time difference={(Time1+b)−(TIME+b−a)} or
Time difference={(Time1)−(TIME−a)}

If the time difference is positive, the time of the controller terminal is later than the time of the agent terminal; if the time difference is negative, the time of the controller terminal is earlier than the time of the agent terminal. In such a case, to adjust the time of the controller terminal to the time of the agent terminal, the time difference between the terminals is reflected on the time Time2 (1108) at the time adjustment time of the controller terminal as follows.
Time2=Time2−{(Time1+b)−(TIME+b−a)}
or
Time2=Time2−{(Time1)−(TIME−a)}

In this way, the time of the controller terminal can be adjusted to the time of the agent terminal.

Next, the following describes how to calculate the communication speed between the controller terminal and the agent terminal. When the synchronization between the time of the controller terminal and the time of the agent terminal is established according to the time adjustment procedure described above, the communication speed can be calculated by the following procedure. The time T1 (1110) at which the agent terminal starts sending data and the size of the sending data are sent with the data sent from the agent terminal (1111). Let T2 (1112) be the time at which the reception of data is completed on the controller terminal. Then, the communication speed between the controller terminal and the agent terminal is expressed approximately as “data amount/(T2−T1)” (1113).

The size of sending data can also be calculated from the actual sending data.

FIG. 12 is a flowchart showing that the controller terminal acquires power information and stores it in the temporary saving buffer. After the controller terminal is connected to the agent terminal, the basic control unit of the controller terminal executes the API to acquire the information on the remaining battery capacity, the remaining driving life, and the AC power connection state from the operating system (S1201). The controller terminal stores the acquired information in the power information temporary saving buffer in the format shown in FIG. 5 (S1202) and wait for the operating system to generate a power state change event (S1203). Because the operating system generates a change event when the power state is changed, the controller terminal captures this event (S1204) and acquires the power information in the same manner as in S1201 (S1205). The controller terminal saves the acquired information in the power information temporary saving buffer (S1206) and turns on the update flag at the start of the buffer (S1207). After saving the information, the controller terminal waits for a power state change event and, until the session with the agent terminal is deleted, repeatedly acquires and saves the information each time the change event is captured.

FIG. 13 is a flowchart showing that the controller terminal acquires speaker information and stores it in the temporary saving buffer. After the controller terminal is connected to the agent terminal, the basic control unit of the controller terminal executes the API to acquire the information on the maximum communication band from the operating system and checks if the maximum communication band is at a predetermined speed (57K bps in the figure) or higher (S1301).

If the maximum communication band is equal to or higher than the predetermined speed (S1301-YES), the controller terminal executes the API to acquire the information on the speaker state and the sound volume of the operating system from the operating system (S1302). The controller terminal compares the acquired information with the speaker information saved in the speaker information temporary saving buffer (S1303) and, if they differ (S1303—YES), saves the acquired information in the speaker information temporary saving buffer in the format shown in FIG. 6 (S1304), and turns on the update flag at the start of the buffer (S1305). If the acquired information matches the information saved in the temporary saving buffer (S1303—NO), the controller terminal does not update the temporary saving buffer and the update flag. After that, the controller terminal waits for a predetermined time (S1306) and, after the predetermined time, acquires the speaker information again. Until the session with the agent terminal is deleted, the controller terminal repeatedly acquires and saves the information at a regular interval.

If the maximum communication band is lower than the predetermined speed (S1301—NO), the controller terminal sets the sound non-reproducible state in the speaker state of the speaker information (S1307), stores the speaker state in the temporary saving buffer (S1308), turns on the update flag (S1309), and terminates the processing.

FIG. 14 is a flowchart showing that the controller terminal acquires communication information and stores it in the temporary saving buffer. After the controller terminal is connected to the agent terminal, the basic control unit of the controller terminal establishes the synchronization in time between the operating system of the controller terminal and the operating system of the agent terminal and adjusts the time (S1401). After the time adjustment, the controller terminal sends dummy data to the agent terminal and calculates the actual data transfer speed to find the communication speed (S1402). Although an example of the time adjustment method and the communication speed calculation method is shown in FIG. 11, the methods are not limited to those shown in the example. Next, the controller terminal executes the API to acquire the information on the maximum communication band, the network type, and the electric wave intensity from the operating system (S1403). The controller terminal compares the information acquired in S1402 and S1403 with the information saved in the communication information temporary saving buffer (S1404) and, if they differ (S1404—YES), saves the acquired information in the communication information temporary saving buffer in the format shown in FIG. 7 (S1405), and turns on the update flag at the start of the buffer (S1406). If the acquired information matches the information saved in the temporary saving buffer (S1404—NO), the controller terminal does not update the temporary saving buffer and the update flag. After that, the controller terminal waits for a predetermined time (S1407) and, after the predetermined time, acquires the communication information again. Until the session with the agent terminal is deleted, the controller terminal repeatedly acquires and saves the information at a regular interval.

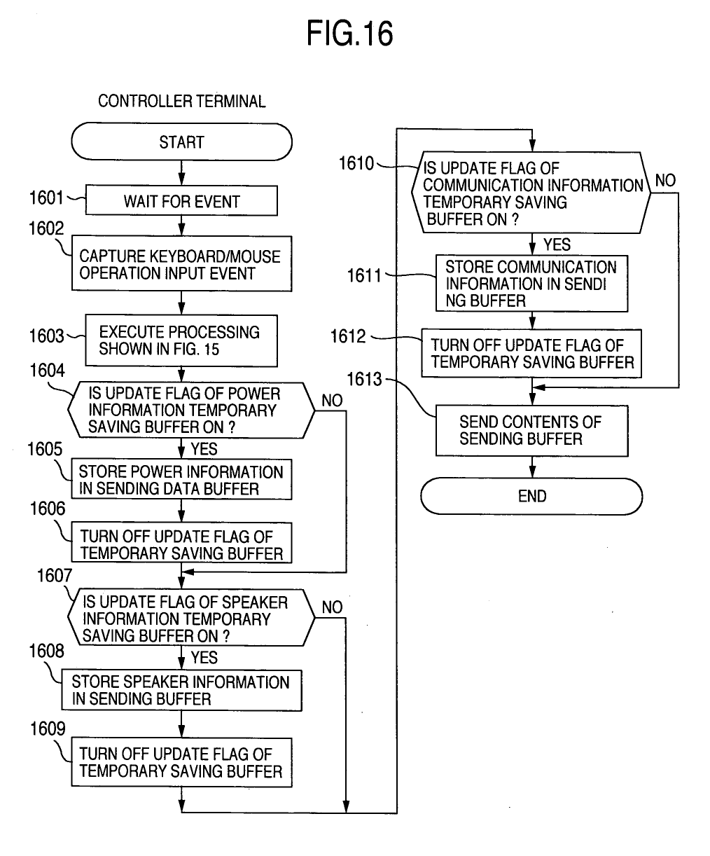

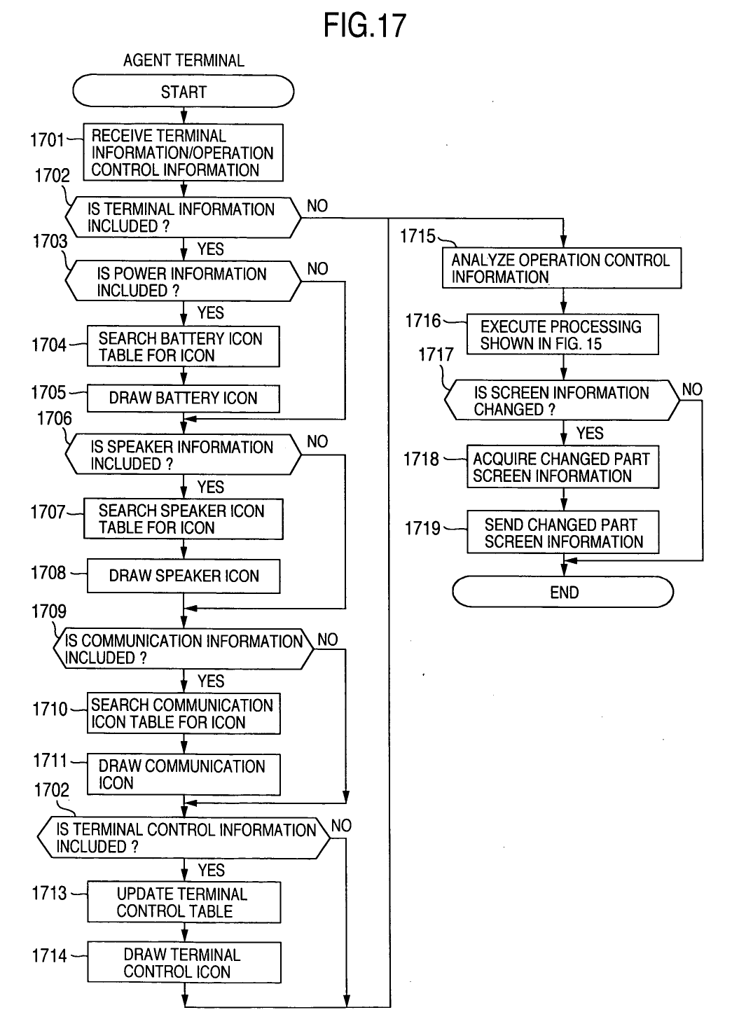

FIG. 15 is a flowchart, common to the controller terminal and the agent terminal, showing that a keyboard/mouse input event is analyzed and the actual processing is executed.

A check is made whether a keyboard/mouse input event is an event to a specific area (1501). A specific area refers to an area where terminal information on the controller terminal is displayed, and the check is made whether the event is an input to the task tray or a transparent window. If the input is not an input to the specific area (S1501—NO), the input processing for the agent screen is performed (1502). When the controller terminal performs this processing, it encodes the captured operation event and stores it in the sending buffer as the operation control information. When the agent terminal performs this processing, it sends the operation event to an application or the operating system. If the input is an input to the specific area (S1501—YES) and is an input to a terminal control icon (S1503—YES), the terminal acquires the control icon ID corresponding to the specified terminal control icon (1505) and searches the terminal control information definition table (1506) to perform control processing for the controller terminal (1507). When the controller terminal performs this processing, it sends the control command defined in the terminal control information definition table to the operating system. For the shutdown or the reboot instruction, the controller terminal sends a termination notification to the agent terminal and terminates the program. When the agent terminal performs this processing, it sends the terminal control instruction shown in FIG. 9 to the controller terminal. The operation event is sent to an application or the operating system. If the input is not an input to a terminal control icon (S1503—NO), the detailed information on the controller terminal corresponding to the specified terminal information icon is displayed (1504).

FIG. 16 is a flowchart showing that the controller terminal captures a keyboard/mouse input event and sends the sending buffer data to the agent terminal.

The basic control unit of the controller terminal waits for a keyboard/mouse input event (S1601) and, when an operation event occurs, captures the operation event (S1602). The processing is executed according to the flowchart shown in FIG. 15 (S1603). The procedure for storing power information in the sending buffer is as follows. The update flag of the power information temporary saving buffer is checked (S1604). If the update flag is on (S1604—YES), the power information is stored in the sending buffer (S1605) and the update flag is turned off (S1606). If the update flag is off (S1604—NO), the power information is not stored in the sending buffer and therefore the power information is not added.

The procedure for storing speaker information and communication information in the sending buffer is the same as that for storing power information in the sending buffer. The update flag of the temporary saving buffer is checked (S1607, S1610). If the update flag is on (S1607—YES, S1610—YES), the information is stored in the sending buffer (S1608, S1611) and the update flag of the temporary saving buffer in which the information is stored is turned off (S1609, S1612). If the update flag is off (S1607—NO, S1611—NO), the information is not stored in the sending buffer and therefore the information not stored is not added. The information is stored in the sending buffer and sent to the agent terminal according to the procedure described above.

FIG. 17 is a flowchart showing the processing of the agent terminal for analyzing information sent from the controller terminal.

The basic control unit of the agent terminal receives information, sent from the controller terminal (S1701), and analyzes the received data. The agent terminal checks the length of the received data to find whether the received data includes the terminal information in addition to the operation control information (S1702). If the terminal information is stored (S1702—YES), the agent terminal checks the flag in the first byte of the terminal information and acquires the information.

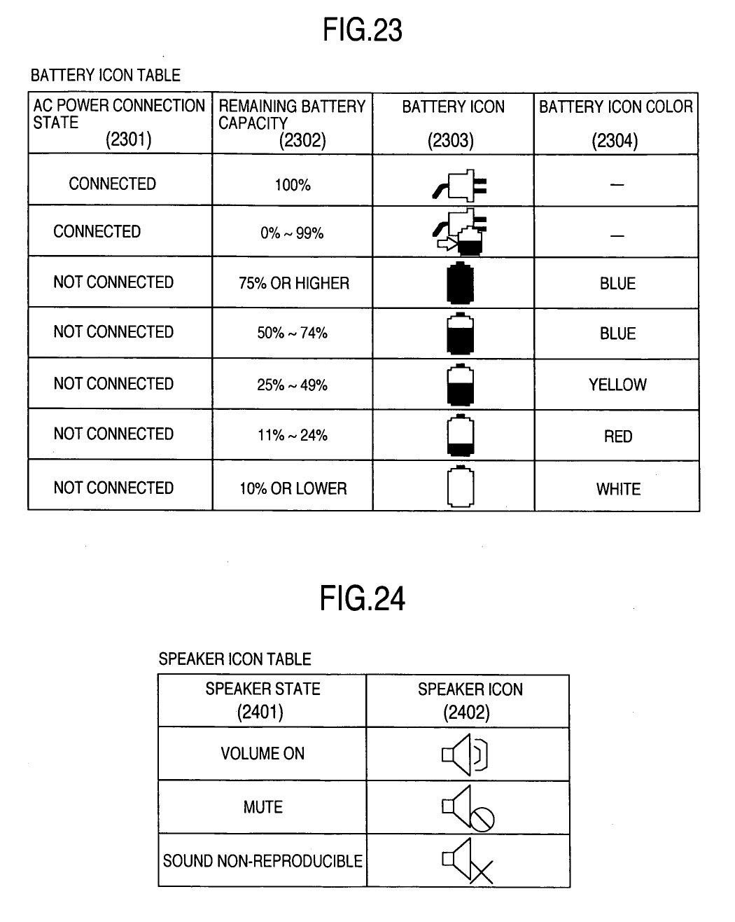

If the flag in the first byte is ‘B’ (S1703—YES), the agent terminal determines that the following data is power information and, based on the buffer format in FIG. 5, acquires the power information. Based on the AC power connection state and the remaining battery capacity included in the acquired power information, the agent terminal searches the battery icon table in FIG. 23 for a battery icon and the color of the battery icon (S1704). After acquiring the battery icon and the color, the agent terminal draws or redraws the battery icon in a predetermined position of the agent terminal screen (S1705). If the flag in the first byte is not ‘B’ (S1703—NO), the agent terminal does not draw or redraw a battery icon assuming that the power information was not updated.

If the flag in the first byte is ‘S’ (S1706—YES), the agent terminal determines that the following data is speaker information and, based on the buffer format in FIG. 6, acquires the speaker information. Based on the speaker state included in the acquired speaker information, the agent terminal searches the speaker icon table in FIG. 24 for a speaker icon (S1707). After acquiring the speaker icon, the agent terminal draws or redraws the speaker icon in a predetermined position of the agent terminal screen (S1708). If the flag in the first byte is not ‘S’ (S1706—NO), the agent terminal does not draw or redraw a speaker icon assuming that the speaker information was not updated.

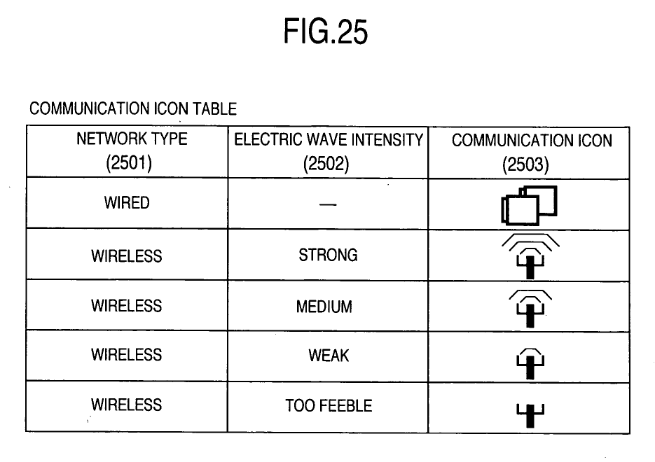

If the flag in the first byte is ‘C’ (S1709—YES), the agent terminal determines that the following data is communication information and, based on the buffer format in FIG. 7, acquires the communication information. Based on the network type and the electric wave intensity included in the acquired communication information, the agent terminal searches the communication icon table in FIG. 25 for a communication icon (S1710). After acquiring the communication icon, the agent terminal draws or redraws the communication icon in a predetermined position of the agent terminal screen (S1711). If the flag in the first byte is not ‘C’ (S1709—NO), the agent terminal does not draw or redraw a communication icon assuming that the communication information was not updated.

If the flag in the first byte is ‘P’ (S1712—YES), the agent terminal determines that the following data is terminal control information and, based on the table format in FIG. 10, acquires the terminal control information. The agent terminal adds the acquired terminal control information to the terminal control information definition table held by the agent terminal (1713) and draws or redraws the terminal control icon (S1714). If the flag in the first byte is not ‘P’ (S1712—NO), the agent terminal does not draw or redraw a terminal control icon assuming that the terminal control information was not updated.

If terminal information is not stored (S1702—NO), the battery icon, speaker icon, communication icon, and terminal control icon are not updated. After analyzing the terminal information, the agent terminal analyzes the keyboard/mouse input, encoded by the controller terminal, based on the operation control information in the received data (S1715) and executes the processing according to the flowchart shown in FIG. 15 (S1716). If the screen information on the agent terminal is changed (S1717—YES), the display driver hook control unit captures the drawing instruction for the changed part (S1718) and sends it to the controller terminal as the screen information on the changed part (S1719).

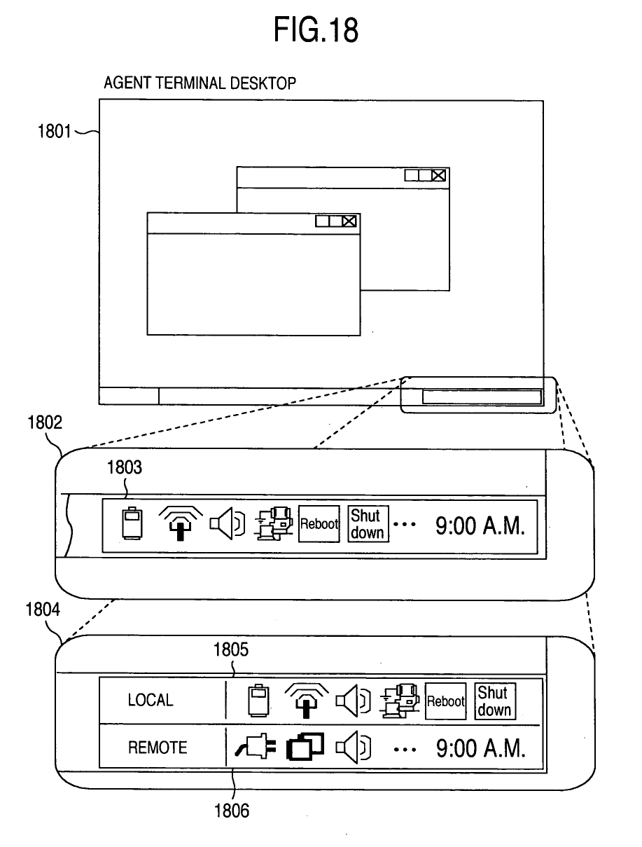

FIG. 18 shows an example in which icons representing terminal information are displayed in the task tray on the agent terminal screen. The screen information displayed on the agent terminal in this manner is displayed also on the controller terminal screen in the same way according to the method described above. The numerals 1802 and 1804 indicate the enlarged illustration of the task tray on the desktop 1801 of the agent terminal. The numeral 1802 indicates an example in which the icons of the controller terminal are displayed in the area of the task tray 1803 of the agent terminal. It is also possible that, as shown by the numeral 1804, the area is divided into two, one is “Remote” 1806 for the icons of the task tray of the agent terminal and the other is “Local” 1805 for the icons of the controller terminal, to allow the user to know to which terminal, agent or controller, the displayed icons belong.

In this case, when an input to an icon is received, the operating system sends an input notification to the basic control unit. In response to the notification, the basic control unit checks if the input is issued to an icon corresponding to the controller terminal information and, if so, sends the control instruction to the controller terminal.

The information on the position or the area where a transparent window or a bit map icon is displayed is stored in the memory of the agent terminal or a storage device such as a hard disk. The transparent window or the bit map icon is drawn in the predetermined position or area.

This display position can also be changed. An icon in the task tray on the controller terminal can be dragged and dropped in any position on the screen. The information on the new position, to which the icon is moved, is sent from the controller terminal to the agent terminal and the agent terminal stores the changed position information. After that, the icon is displayed in the new position. Not only the display position but also the display area can be changed as necessary.

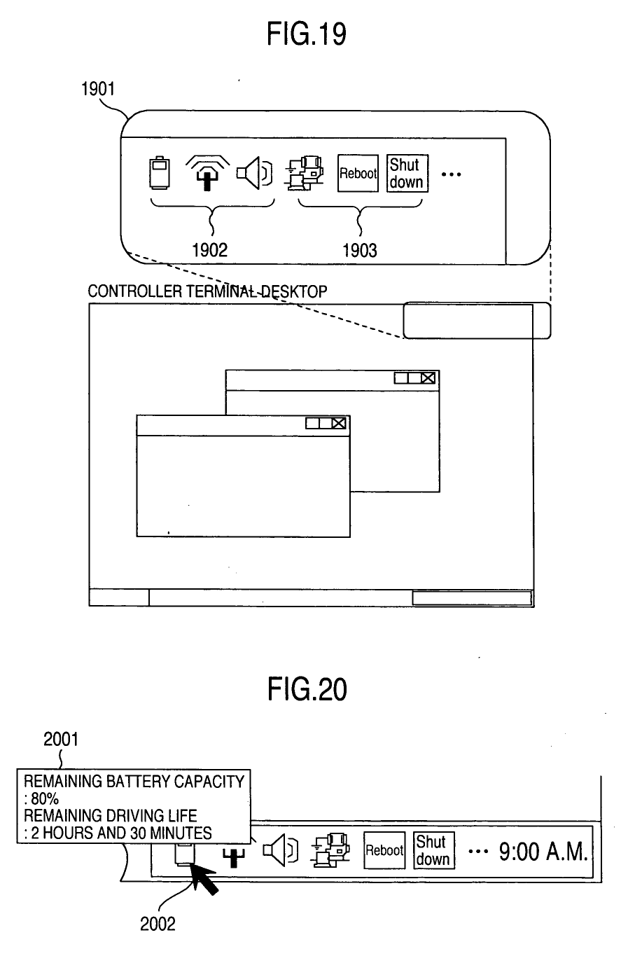

FIG. 19 shows an example in which icons indicating terminal information and control icons indicating programs and the controller terminal are displayed on the desktop of the controller terminal. As described above, it is possible to process the information once into the screen information of the agent terminal and then send the processed information to the controller terminal; instead of this, the controller terminal itself can also display the terminal information as shown in FIG. 19. The numeral 1901 indicates an enlarged display of a part of the desktop of the controller terminal. On the desktop of the controller terminal, the icons 1902 indicating the terminal information and the control icons 1903 indicating a program and a terminal are processed into a transparent window display, and the controller terminal overlaps the transparent window on the received agent terminal screen information. The agent terminal screen, which is the underlying images of the icons, is visible transparently. The icons 1902 and 1903 can be selected and moved to any area through the drag and drop operation.

The area (coordinates (X, Y)−(X1, Y1)), where the information on the controller terminal is displayed, is distinguished from the drawing area of the agent terminal itself and is managed as a special area in the memory of the controller terminal or in a storage device such as a hard disk. An input to this area, which is treated as operation control information, is not sent to the agent terminal but is captured and processed by the controller terminal. When the transparent window is moved, the coordinates managed in the storage device are updated.

In this case, if a keyboard/mouse input is an input to one of the displayed icons 1902 indicating the terminal information, the detailed information on the acquired terminal information is displayed. The contents of the display will be described later with reference to FIGS. 20-22. If the input is an input to one of the control icons 1903 indicating a program or a terminal, the program is started or the terminal control is performed. More specifically, the start command of the program corresponding to the displayed icon is issued to the operating system of the controller terminal. Alternatively, the API of the operating system of the controller terminal is used to execute the command or to shut down or reboot the system.

Although a keyboard or mouse operation event to an icon in the transparent window is captured in this embodiment, it is also possible to capture only a specific input such as a double click. In this case, the controller terminal sends an operation event, other than that of the specific input, to the agent terminal assuming that the operation is for the agent terminal screen.

FIG. 20 shows an example of a popup window displayed when the battery icon is pointed by the mouse. When the battery icon displayed in the task tray or on the desktop is pointed (2002), a popup window 2001 is displayed. When the popup window 2001 is displayed, the power information stored in the buffer of the agent terminal is acquired and the values of the remaining battery capacity and the remaining driving life are displayed as the detailed information.

The agent terminal may draw this popup window and send the screen information to the controller terminal, or the controller terminal may draw this popup window based on the power information sent from the agent terminal.

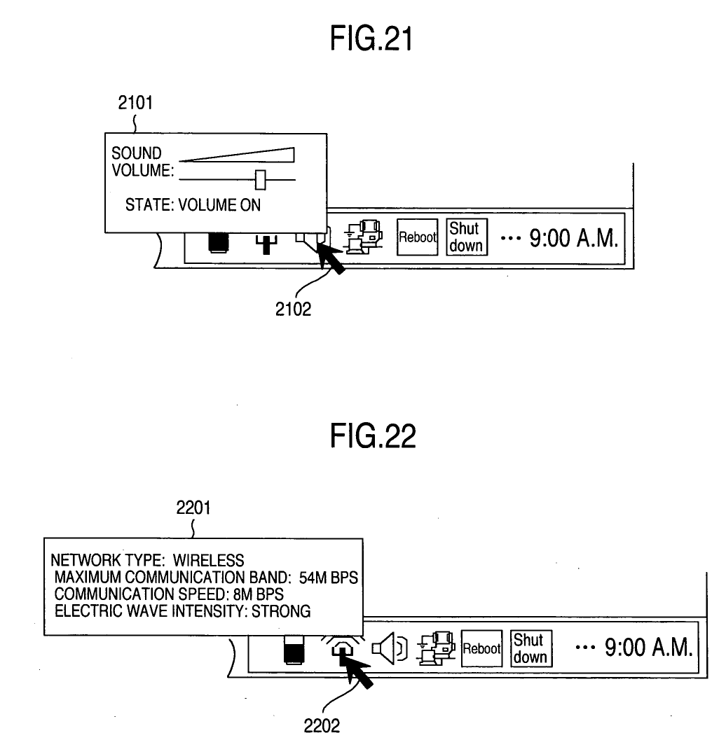

FIG. 21 shows an example of a popup window displayed when the speaker icon is pointed by the mouse. When the speaker icon displayed in the task tray or on the desktop is pointed (2102), a popup window 2101 is displayed. When the popup window 2101 is displayed, the speaker information stored in the buffer of the agent terminal is acquired and the sound volume and the speaker state are displayed as the detailed information.

When the user moves the slide bar of the sound volume information displayed in FIG. 21, the mouse operation event is captured and the speaker sound volume of the controller terminal is changed to the changed sound volume specified by the slide bar. In addition, the sound volume at this time is sent to the agent terminal as the speaker information. The speaker information stored in the buffer of the agent terminal is acquired and the sound volume and the speaker state, which have been changed, are redrawn.

FIG. 22 shows an example of a popup window displayed when the communication icon is pointed by the mouse. When the communication icon displayed in the task tray or on the desktop is pointed (2202), a popup window 2201 is displayed. When the popup window 2201 is displayed, the communication information stored in the buffer of the agent terminal is acquired and the values of the network type, maximum communication band, communication speed, and electric wave intensity are displayed as the detailed information.

FIG. 23 shows the battery icon table referenced when the agent terminal draws the battery icon. The agent terminal analyzes the data sent in the sending buffer format shown in FIG. 8 and, if the power information 802 is included, references the battery icon table based on the information on a remaining battery capacity 2302 and an AC power connection state 2301, included in the power information 802, to acquire a battery icon 2303 and a battery icon color 2304 that indicate the battery state.

FIG. 24 shows the speaker icon table referenced when the agent terminal draws the speaker icon. The agent terminal analyzes the data sent in the sending buffer format shown in FIG. 8 and, if the speaker information 803 is included, references the speaker icon table based on the information on a speaker state 2401, included in the speaker information 803, to acquire a speaker icon 2402 that indicates the speaker state.

FIG. 25 shows the communication icon table referenced when the agent terminal draws the communication icon. The agent terminal analyzes the data sent in the sending buffer format shown in FIG. 8 and, if the communication information 804 is included, references the communication icon table based on the information on a network type 2501 and an electric wave intensity 2502, included in the communication information 804, to acquire a communication icon 2503 that indicates the communication state. For the communication information 804, an icon indicating the communication speed may also be provided, in addition to the icon indicating the electric wave intensity, to display the communication speed.

The terminal information may include not only the power information, battery information, communication information, and speaker information but also information on the state and the setting of the controller terminal. For example, the terminal information may include the information on the performance of the controller terminal, such as the information on the CPU (load, performance, etc.) and the memory (memory capacity, memory usage state, memory usage ratio, cache hit ratio, etc.) of the controller terminal.

The embodiments described above may be changed or combined as necessary without departing from the spirit of the present invention.

1. A computer information display method for displaying screen information on a second computer on a display of a first computer in a system where said first computer and said second computer are connected via a network, said computer information display method comprising the steps of:
sending computer information on said first computer from said first computer to said second computer;
receiving, by said second computer, the computer information and then acquiring modified screen information created by adding at least a part of the received computer information to the screen information on said second computer;
sending the modified screen information from said second computer to said first computer; and
receiving, by said first computer, the modified screen information and displaying the received modified screen information on the display of said first computer.

2. The computer information display method according to claim 1, wherein the computer information added to the screen information on said second computer is information on an icon represented by bit map data.

3. The computer information display method according to claim 2, further comprising the step of, when a mouse cursor is placed on an icon on the display of said first computer, displaying detailed information on the computer information, said icon displayed using the computer information.

4. The computer information display method according to claim 1, further comprising the steps of:
accepting an operation event to a modified screen displayed on the display of said first computer;
sending the operation event to said second computer; and
if it is found in said second computer that the received operation event is an input to terminal control information of the computer information on said first computer, sending a terminal control instruction from said second computer to said first computer.

5. The computer information display method according to claim 1 wherein an area where the computer information added to the screen information on said second computer is a transparent window through which underlying images can be seen.

6. The computer information display method according to claim 1 wherein the computer information is information on a battery of said first computer.

7. The computer information display method according to claim 1 wherein the computer information is information on a sound volume of said first computer.

8. The computer information display method according to claim 1 wherein the computer information is information on a system inventory, such as a disk capacity or memory capacity, of said first computer.

9. The computer information display method according to claim 1 wherein the computer information is information on a state of the network via which said first computer and said second computer are connected.

10. The computer information display method according to claim 1 wherein the computer information is information on a data transfer from said second computer to said first computer.

11. A computer information display method for displaying screen information on a second computer on a display of a first computer in a system where said first computer and said second computer are connected via a network, said computer information display method comprising the steps of:
sending screen information on said second computer to said first computer;
adding, by said first computer, a transparent window to the screen information on said second computer, said transparent window displaying therein computer information on said first computer; and
displaying a modified screen information on said second computer, to which the computer information is added, on the display of said first computer.

12. The computer information display method according to claim 11, wherein the computer information added to the screen information on said second computer is information on an icon represented by bit map data.

13. The computer information display method according to claim 12, further comprising the step of, when a mouse cursor is placed on an icon on the display of said first computer, displaying detailed information on the computer information, said icon displayed using the computer information.

14. The computer information display method according to claim 11, further comprising the steps of:
accepting an operation event to a modified screen displayed on the display of said first computer; and
if the received operation event is an input to terminal control information of the computer information on said first computer displayed in the transparent window, performing a control operation corresponding to the terminal control information.

15. The computer information display method according to claim 11 wherein the computer information is information on a battery of said first computer.

16. A computer information display system, where a first computer and a second computer are connected via a network, for displaying screen information on said second computer on a display of said first computer, said computer information display system comprising:
a communication module for sending computer information on said first computer from said first computer to said second computer;
a screen combination processing unit, provided in said second computer, for adding the computer information to the screen information on said second computer;
a communication control unit for sending the screen information on said second computer, to which the computer information is added, from said second computer to said first computer; and
a display control unit for displaying the screen information on said second computer on the display of said first computer.
